(19) United States
(12) Patent Application Publication
(10) Pub. No.: US 2026/0267449 A1
(43) Pub. Date: Sep. 10, 2026

(54) TOUCH SENSOR

(71) Applicant: Panasonic Intellectual Property Management Co., Ltd., Kadoma-shi, Osaka (JP)

(72) Inventors: Ryo Yamaguchi, Okayama Ken (JP); Hiromitsu Niwa, Gifu Ken (JP); Mitsuru Satou, Kanagawa Ken (JP)

(73) Assignee: Panasonic Intellectual Property Management Co., Ltd., Kadoma-shi, Osaka (JP)

(21) Appl. No.: 19/165,267

(22) PCT Filed: Apr. 2, 2024
(86) PCT No.: PCT/JP2024/013602

§ 371 Date: Sep. 15, 2025

(30) Foreign Application Priority Data
Apr. 10, 2023 (JP) 2023-063580

(51) Int. Cl. G06F 3/044

(52) U.S. Cl. CPC G06F 3/0446; G06F 3/0448; G06F 2203/04112

(57) ABSTRACT

A touch sensor includes: a first electrode that extends along a first direction; and a second electrode that extends along a second direction orthogonal to the first direction and overlaps the first electrode in a top view. The first electrode includes a first cell having a quadrangular shape, and the second electrode includes a second cell having a quadrangular shape. The length of the first cell along the first direction is greater than the length of the first cell along the second direction, and the length of the second cell along the second direction is greater than the length of the second cell along the first direction. The second cell includes a first side containing a first intersection point and a second intersection point, the first and second intersection points overlapping the first cell in a top view.

### TECHNICAL FIELD

The present invention relates to a touch sensor.

### BACKGROUND ART

Capacitive touch sensors have been known, such as the one disclosed in Patent Document 1, for example.

Specifically, Patent Document 1 discloses the touch sensor that includes a conductive film. The conductive film includes a substrate, a plurality of first electrode patterns, and a plurality of second electrode patterns. The first electrode patterns and the second electrode patterns face each other across the substrate and intersect each other. Each of the first and second electrode patterns is configured such that a plurality of cells, formed by a plurality of thin metal wires, are combined together. The area of each intersection portion, where a first electrode pattern intersects a second electrode pattern, is greater than 1 mm² and less than 20 mm².

### CITATION LIST

### Patent Document

PATENT DOCUMENT 1: International Publication No. WO2015/060059

### SUMMARY OF THE INVENTION

### Technical Problem

In the technical field of touch sensors, indium tin oxide (ITO) has been widely used as an example of a material forming an electrode. Known electrodes made of ITO have characteristics that the electrodes tend to have relatively large resistance and that the current response speed between the electrodes tends to decrease as the size of the touch sensor increases. Because of such characteristics, a touch sensor employing electrodes made of ITO may not have achieved sufficient accuracy in detecting touch actions (“touch detection accuracy”). Due to this, the touch sensor of Patent Document 1 aimed to improve touch detection accuracy by using electrode patterns each formed by a plurality of thin metal wires and by specifically defining the area of each intersection portion between the first electrode pattern and the second electrode pattern.

However, at the intersection portion between the first electrode pattern and the second electrode pattern of the touch sensor of Patent Document 1, the plurality of thin metal wires are not present over the entire area of the intersection portion (i.e., the region specified at the intersection portion). That is, most of the area of the intersection portion is occupied by a portion where the plurality of thin metal wires are not present (see FIG. 6 of Patent Document 1). For this reason, in the configuration using such electrode patterns formed by a plurality of thin metal wires, it has not been possible to properly calculate the capacitance of the electrodes, even if a specific numerical value for the area of the above-mentioned intersection portion is substituted into the variable corresponding to “the area of the electrodes” in the general formula for calculating the capacitance (specifically, the general formula expressing that the capacitance is proportional to the “permittivity of the electrodes” and “the area of the electrodes,” while it is inversely proportional to “the distance between the electrodes”). That is, simply specifying the area of the intersection portion has been insufficient as a factor for optimizing touch detection accuracy.

The present disclosure has been made in view of the above issue, and an object of the present disclosure is to optimize touch detection accuracy in a touch sensor.

### Solution to the Problem

To achieve the above-described object, a touch sensor according to an embodiment of the present disclosure includes: a first electrode that extends along a first direction; and a second electrode that extends along a second direction orthogonal to the first direction and overlaps the first electrode in a top view. The first electrode includes a first cell having a quadrangular shape. The second electrode includes a second cell having a quadrangular shape. The length of the first cell along the first direction is greater than the length of the first cell along the second direction. The length of the second cell along the second direction is greater than the length of the second cell along the first direction. The second cell includes a first side containing a first intersection point and a second intersection point, the first and second intersection points overlapping the first cell in a top view.

### Advantages of the Invention

According to the present disclosure, touch detection accuracy can be optimized in a touch sensor.

### BRIEF DESCRIPTION OF THE DRAWINGS

FIG. 1 is an overall perspective view of a touch sensor according to an embodiment of the present disclosure.

FIG. 2 is a cross-sectional view taken along line II-II of FIG. 1.

FIG. 3 is a transparent view schematically showing the touch sensor as viewed from the front surface.

FIG. 4 is a schematic view showing transmission electrodes, first wiring portions, and pads as viewed from the back surface of a substrate.

FIG. 5 is a schematic view showing reception electrodes, second wiring portions, and pads as viewed from the front surface of the substrate.

FIG. 6 is a partially enlarged view of the part VI shown in FIG. 3.

FIG. 7 schematically shows a configuration of a mesh pattern in the transmission electrode.

FIG. 8 schematically shows a configuration of a mesh pattern in the reception electrode and a configuration of dummy electrodes.

FIG. 9 is a partially enlarged view of the part IX shown in FIG. 6.

FIG. 10 is a partially enlarged view schematically showing a state in which the mesh pattern constituting the transmission electrode and the mesh pattern constituting the reception electrode superimposed with each other.

FIG. 11 is a partially enlarged view schematically showing a state in which an arbitrary cell, constituting the reception electrode, and a dummy pattern in the cell intersect a plurality of fine lines constituting the transmission electrode.

FIG. 12 is a cross-sectional view schematically showing a cross section of a fine line.

FIG. 13 is a graph showing the results obtained through simulation, for each thickness of the touch sensor, regarding the relationship between the number of intersection points A included in a unit area and the capacitance (see Table 1).

FIG. 14 is a diagram corresponding to FIG. 11 and showing another embodiment of the dummy pattern in an arbitrary cell constituting the reception electrode.

### DESCRIPTION OF EMBODIMENTS

Embodiments of the present disclosure will be described below in detail with reference to the drawings. Note that the following description of the embodiments is merely an example in nature, and is not intended to limit the scope, applications, or use of the present disclosure.

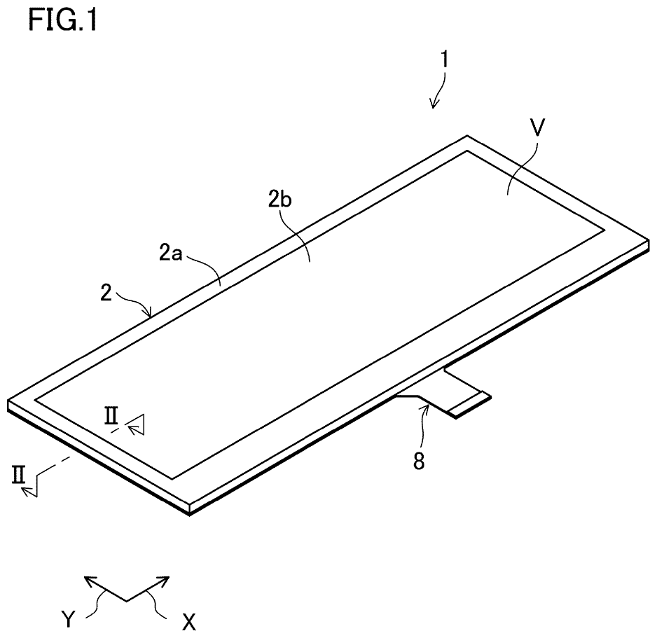

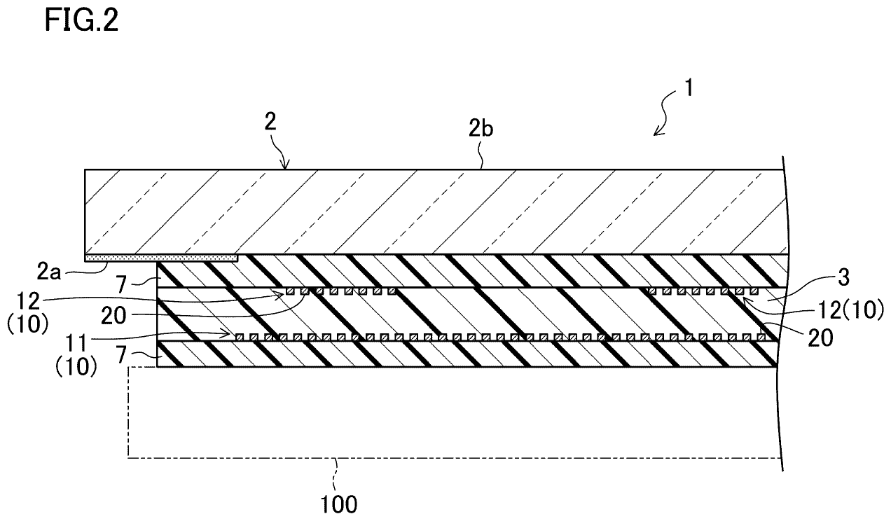

FIG. 1 shows the entirety of a touch sensor 1 according to an embodiment of the present disclosure. The touch sensor 1 is a sensor-type capacitive input device to be applied to a display 100 (see FIG. 2). The touch sensor 1 is used as an input device for, for example, an in-vehicle device such as a car navigation system, a display device of a personal computer, a mobile phone, a portable information terminal, a portable game machine, a copying machine, a ticket vending machine, an automatic teller machine, a clock, or the like.

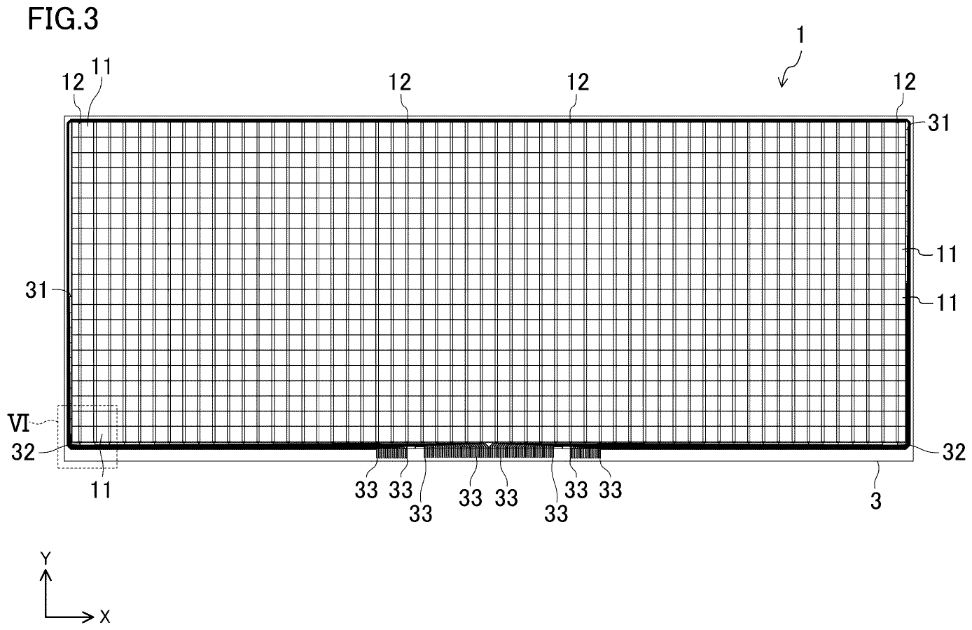

In the following description, the side on which an operation screen 2b of a cover member 2 (see, FIGS. 1 and 2), which will be described later, is located is referred to as the “front” of the touch sensor 1, and its opposite side is referred to as the “back” of the touch sensor 1. On this premise, the positional relationships between the elements constituting the touch sensor 1 will be defined. In this embodiment, for convenience of explanation, the direction from the left to the right on the sheet of FIG. 3 is defined as “first direction X.” while the direction from the bottom to the top on the sheet of FIG. 3 is defined as “second direction Y.”

### (Cover Member)

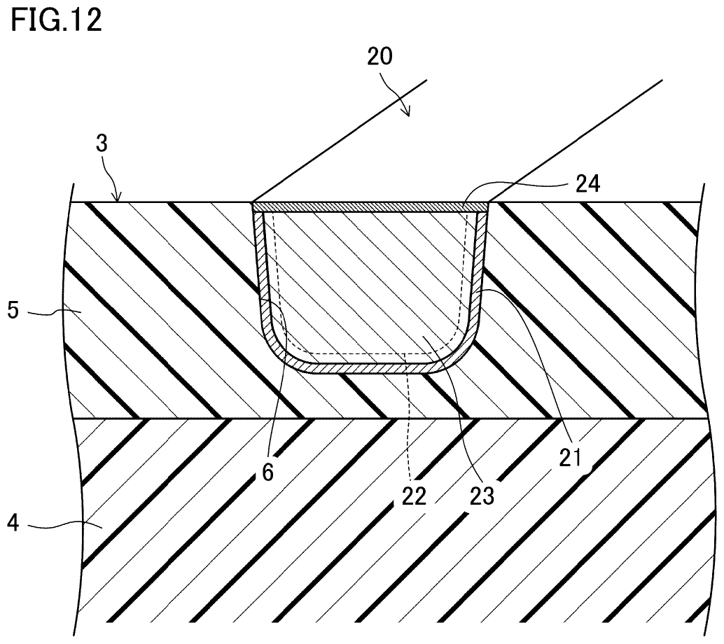

As shown in FIGS. 1 and 2, the touch sensor 1 includes the cover member 2, which has light-transmissive properties. The cover member 2 is, for example, a cover glass or a plastic cover lens. The cover member 2 is, for example, in the shape of a rectangular plate in a plan view. The cover member 2 is fixed to a second layer 5 (see FIG. 12) of a substrate 3, which will be described later.

At a peripheral edge portion on the back surface of the cover member 2, there is a substantially frame-like decorative portion 2a, which is in a dark color such as black and is formed through screen printing or the like. An internal rectangular region surrounded by the decorative portion 2a serves as a light-transmissive view area V. That is, through the view area V, a user can obtain visual information from the display on the back side of the touch sensor 1. A portion of the front surface of the cover member 2, which is within the view area V, serves as the operation screen 2b to be touched by a user's finger or the like as the user performs a touch operation.

### (Substrate)

As shown in FIGS. 2 and 3, the touch sensor 1 includes the single substrate 3. As shown in FIG. 12, the substrate 3 has a first layer 4 and the second layer 5. The first layer 4 and the second layer 5 each have, for example, a substantially rectangular shape in a plan view.

The first layer 4 is made of a transparent resin material. Examples of such a transparent resin material include polyethylene terephthalate (PET), polycarbonate (PC), cycloolefin polymer (COP), and cycloolefin copolymer (COC), for example.

The second layer 5 is stacked on the front surface of the first layer 4. Although not shown, in this embodiment, another second layer 5 is stacked on the back surface of the first layer 4 as well. Each second layer 5 serves as a layer in which a plurality of grooves 6 are formed, which will be described later. Each second layer 5 is made of a resin material having insulating properties and light-transmissive properties. The thickness of the second layers 5 is set to 1.0 μm or more and 10.0 μm or less, for example, to ensure flexibility. The thickness of the second layers 5 is designed to be greater than the depth of the grooves 6, which will be described later.

The plurality of grooves 6 are provided on the front surface of the one second layer 5. Although not shown, the plurality of grooves 6 are also provided on the back surface of the other second layer 5. Each groove 6 has a bottom and is recessed in the thickness direction of the substrate 3. The depth of the grooves 6 is set to 0.9 μm or more and 3.0 μm or less, for example.

### (Adhesive Layer)

As shown in FIG. 2, the touch sensor 1 includes an adhesive layer 7. The adhesive layer 7 is stacked between the cover member 2 and the substrate 3. The adhesive layer 7 is made of an optical clear adhesive (OCA) having light-transmissive properties. The thickness of the adhesive layer 7 is 25 μm or more and 250 μm or less, for example.

### (Flexible Wiring Board)

As shown in FIG. 1, the touch sensor 1 includes a flexible wiring board 8. The flexible wiring board 8 is flexible and has electrical characteristics that are unchanged even in a deformed state. The flexible wiring board 8 is made of a flexible insulating film, such as those made of polyimide (PI), polyethylene terephthalate (PET), or polyethylene naphthalate (PEN), for example.

### (Sensor Electrodes)

The touch sensor 1 includes a plurality of capacitive sensor electrodes.

As shown in FIGS. 3 to 5, the plurality of sensor electrodes include a plurality of first electrodes and a plurality of second electrodes. In this embodiment, the plurality of first electrodes correspond to “a plurality of transmission electrodes 11,” while the plurality of second electrodes correspond to “a plurality of reception electrodes 12.”

The plurality of transmission electrodes 11 and the plurality of reception electrodes 12 are arranged on the substrate 3, correspondingly to the view area V (see FIG. 1). The touch sensor 1 is capable of detecting a touch operation, performed by a user's finger (a detection target) touching the operation screen 2b, through the plurality of transmission electrodes 11 and the plurality of reception electrodes 12, both of which are within the view area V.

Each transmission electrode 11 is connected to a driving circuit (not shown) via the flexible wiring board 8. Each transmission electrode 11 is configured to radiate an electric field around itself by means of the driving circuit. On the other hand, each reception electrode 12 is connected to a detection circuit (not shown) via the flexible wiring board 8. Each reception electrode 12 is configured to receive the electric fields radiated by the transmission electrodes 11.

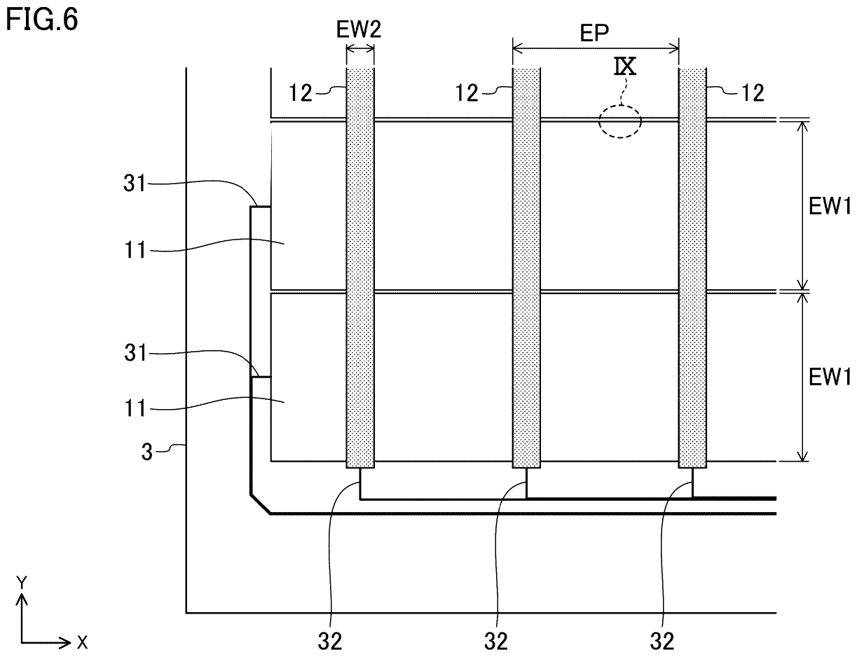

As shown in FIGS. 3 and 6, the transmission electrodes 11 and the reception electrodes 12 are arranged to intersect each other (orthogonally) in a plan view. One node is formed in a region where a transmission electrode 11 and a reception electrode 12 overlap each other. Each node N is configured as a region capable of generating electrostatic capacitance.

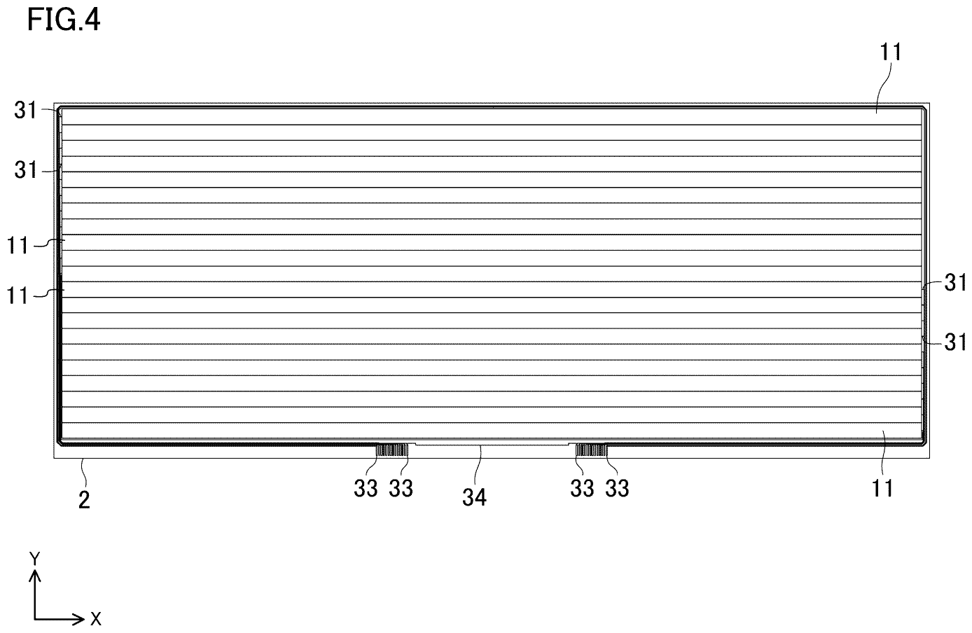

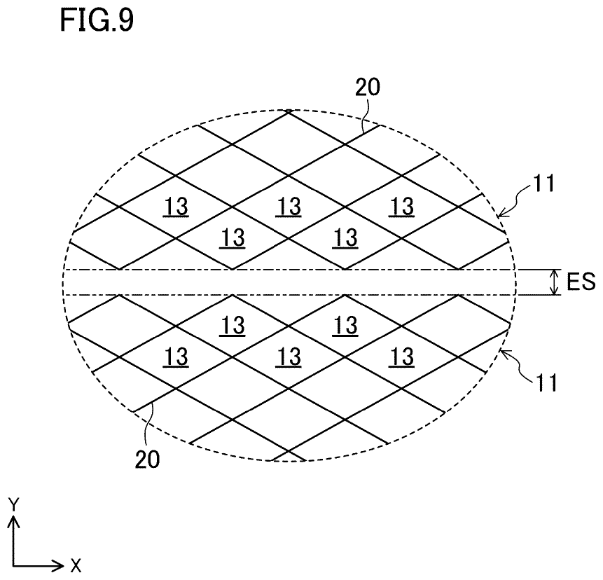

As shown in FIG. 4, the plurality of transmission electrodes 11 are provided on the back surface of the substrate 3. Each transmission electrode 11 extends in the long-side direction of the substrate 3 (the first direction X). The plurality of transmission electrodes 11 are spaced apart from each other in the short-side direction of the substrate 3 (the second direction Y). As shown in FIG. 9, a spacing ES between the transmission electrodes 11, 11 is set to 1 μm or more and 20 μm or less, for example.

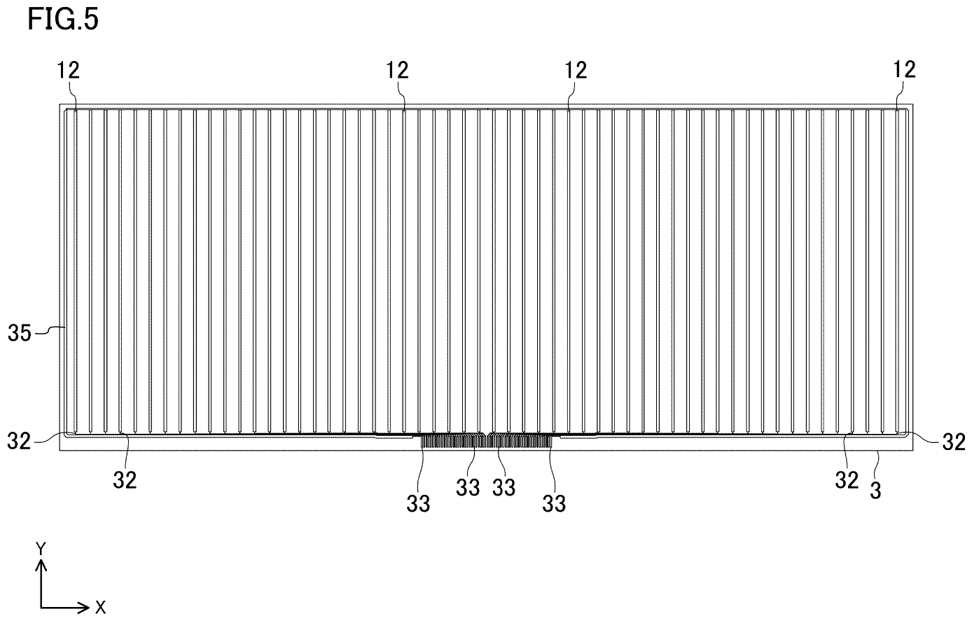

As shown in FIG. 5, the plurality of reception electrodes 12 are provided on the front surface of the substrate 3. That is, the plurality of reception electrodes 12 are arranged on the surface of the substrate 3 that is on the viewing side of the touch sensor 1 (i.e., the surface closer to the operation screen 2b of the cover member 2). The plurality of reception electrodes 12 are insulated from the plurality of transmission electrodes 11 by the substrate 3. Each reception electrode 12 extends in the short-side direction of the substrate 3 (the second direction Y). The plurality of reception electrodes 12 are spaced apart from each other in the long-side direction of the substrate 3 (the first direction X).

As shown in FIG. 6, a pitch EP between the reception electrodes 12, 12 in the first direction X is set to 3 mm or more and 7 mm or less, for example. The reception electrodes 12 are designed to have an electrode width EW2 that is smaller than the pitch EP between the reception electrodes 12, 12. Specifically, the electrode width EW2 of the reception electrodes 12 is, for example, 0.5 mm or more. The electrode width EW2 of the reception electrodes 12 is also designed to be narrower than an electrode width EW1 of the transmission electrodes 11. In FIG. 6, only the reception electrodes 12 are hatched with dots to improve the visibility of how the transmission electrodes 11 and the reception electrodes 12 overlap each other. In FIG. 6, for convenience of illustration, first and second ground portions 34 and 35, which will be described later, are not shown.

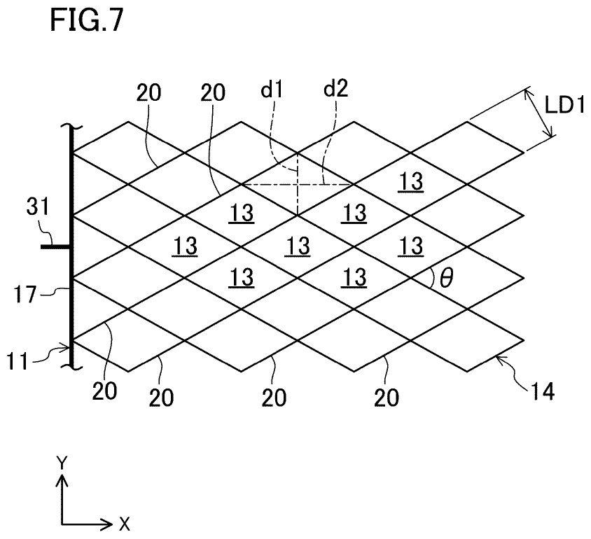

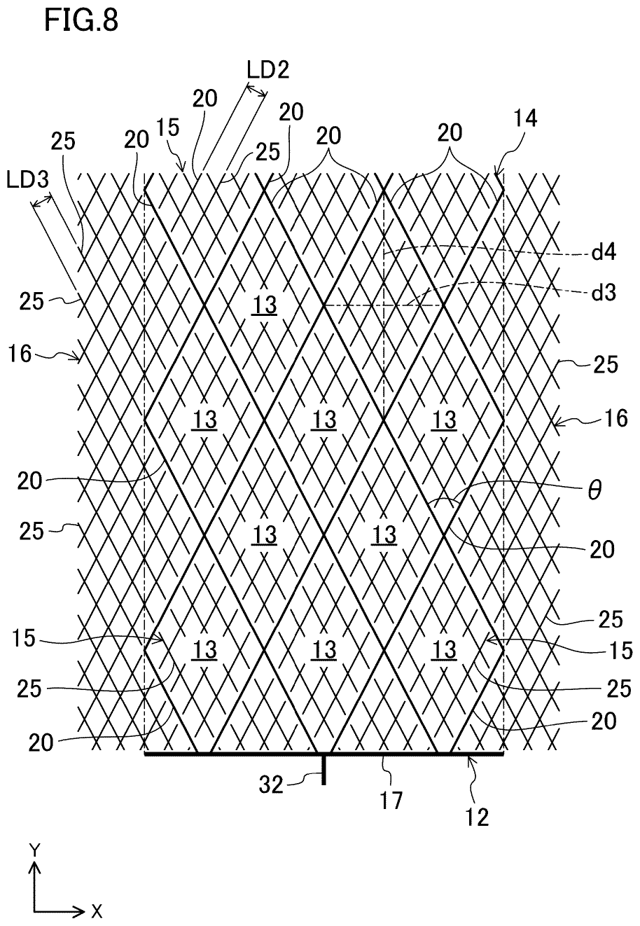

As shown in FIGS. 7 and 8, each transmission electrode 11 and each reception electrode 12 both include a mesh pattern 14. The mesh pattern 14 is designed such that a plurality of cells 13 defined by a plurality of fine lines 20 are arranged. The mesh patterns 14 constituting the transmission electrodes 11 and the mesh patterns 14 constituting the reception electrodes 12 are disposed so as to overlap each other in the thickness direction of the touch sensor 1 (i.e., the thickness direction of the substrate 3). In FIG. 8, for clarity of the outer edge of the reception electrode 12, the position corresponding to the outer edge of the reception electrode 12 is indicated by broken lines.

Each of the cells 13 included in each transmission electrode 11 (first electrode) corresponds to a “first cell” or a “first electrode cell” in the present disclosure. Each of the cells 13 included in each reception electrode 12 (second electrode) corresponds to a “second cell” or a “second electrode cell” in the present disclosure. In the following description, the “first cell” and the “first electrode cell” are collectively referred to as “first cell,” for convenience of explanation. Similarly, the “second cell” and the “second electrode cell” are collectively referred to as “second cell.”

Each fine line 20 is conductive. The plurality of fine lines 20 extend obliquely to each of the first direction X and the second direction Y. The cross-sectional structure of the fine lines 20 will be described later.

The fine lines 20 constituting the transmission electrodes 11 and the reception electrodes 12 have a line width of, for example, 1 μm or more and 3 μm or less. Each transmission electrode 11 is configured so that a distance LD1 between the fine lines 20, 20 adjacent to each other is in the range of 100 μm to 500 μm. Preferably, the distance LD1 is substantially equal to a distance LD2 and a distance LD3, which will be described later.

As shown in FIG. 7, each cell 13 (first cell) of each transmission electrode 11 (first electrode) has a quadrangular shape. The quadrangular shape of the first cell is defined by imaginary first and second diagonal lines d1 and d2. The second diagonal line d2 is set longer than the first diagonal line d1. In this embodiment, the quadrangular shape is a rhombus. The acute angle θ of the rhombus is set within the range of, for example, 50° to 70°. More preferably, the acute angle θ is in the range of 50° to 58°.

As shown in FIG. 7, each transmission electrode 11 (first electrode) is configured such that the second diagonal line d2 of each first cell extends along the extending direction of the transmission electrode 11 (first electrode). In the transmission electrode 11 (first electrode), the second diagonal line d2 of each cell 13 (first cell) extends along the first direction X. That is, in the first electrode, the length of each first cell along the first direction X is greater than the length of the first cell along the second direction Y. In addition, the length of each first cell along the first direction X is equal to the length of the first diagonal line d1 of the first cell, which extends along the first direction X. The length of each first cell along the second direction Y is equal to the length of the second diagonal line d2 of the first cell, which extends along the second direction Y.

Thus, in the transmission electrode 11 (first electrode), the relatively long second diagonal line d2 of each cell 13 (first cell) is along the first direction X. Due to this configuration, in each transmission electrode 11, the number of cells 13 arranged in the extending direction of the transmission electrode 11 (the first direction X) is smaller in comparison to a configuration not included in the present disclosure (i.e., an unillustrated configuration in which the shorter first diagonal line d1 is along the first direction X). More specifically, in the embodiment of the present disclosure, the number of intersection points between the fine lines 20, 20 in the extending direction of the transmission electrode 11 is smaller in comparison to the configuration not included in the present disclosure.

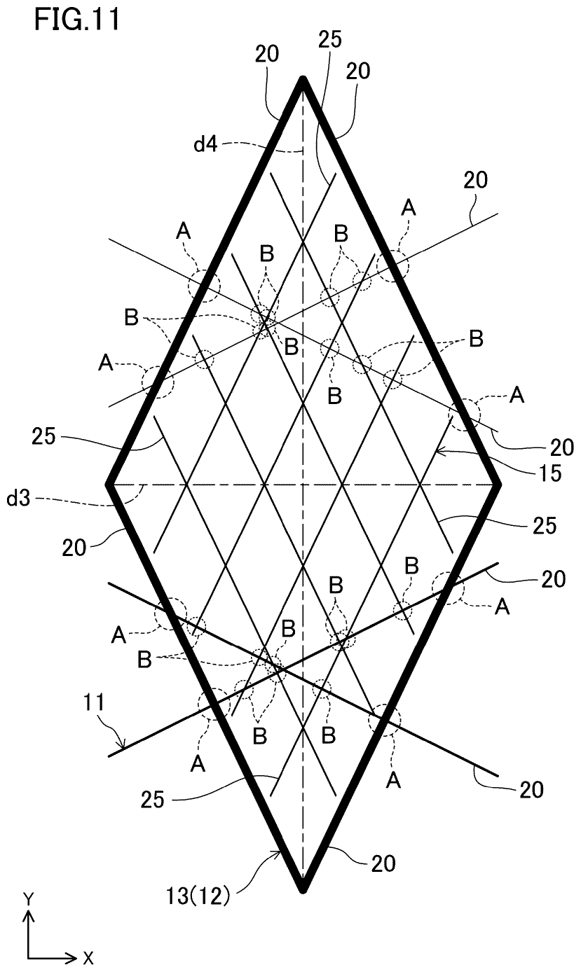

As shown in FIGS. 8 and 11, each cell 13 (second cell) of each reception electrode 12 (second electrode) has a quadrangular shape. The quadrangular shape is defined by imaginary third and fourth diagonal lines d3 and d4. The fourth diagonal line d4 is set longer than the third diagonal line d3. In this embodiment, the quadrangular shape is a rhombus. The acute angle θ of the rhombus is set within the range of, for example, 50° to 70°. More preferably, the acute angle θ is in the range of 50° to 58°. In this embodiment, each cell 13 (second cell) constituting each reception electrode 12 is designed to be larger than each cell 13 (first cell) constituting each transmission electrode 11.

As shown in FIG. 8, each reception electrode 12 (second electrode) is configured such that the fourth diagonal line d4 of each second cell extends along the extending direction of the reception electrode 12 (second electrode). In the reception electrode 12 (second electrode), the fourth diagonal line d4 of each cell 13 (second cell) extends along the second direction Y. In each reception electrode 12 (second electrode), the length of each cell 13 (second cell) along the second direction Y is greater than the length of the second cell along the first direction X. That is, the length of the second cell along the second direction Y is greater than the length of the second cell along the first direction X. The length of the second cell along the second direction Y is equal to the length of the third diagonal line d3 of the second cell, which extends along the second direction Y. The length of the second cell along the first direction X is equal to the length of the fourth diagonal line d4 of the second cell, which extends along the first direction X.

Thus, in the reception electrode 12, the relatively long fourth diagonal line d4 of each cell 13 (second cell) is along the second direction Y. Due to this configuration, in each reception electrode 12, the number of cells 13 arranged in the extending direction of the reception electrode 12 (the second direction Y) is smaller in comparison to a configuration not included in the present disclosure (i.e., an unillustrated configuration in which the shorter third diagonal line d3 is along the second direction Y). More specifically, in the embodiment of the present disclosure, the number of intersection points between the fine lines 20, 20 in the extending direction of the reception electrode 12 is smaller in comparison to the configuration not included in the present disclosure.

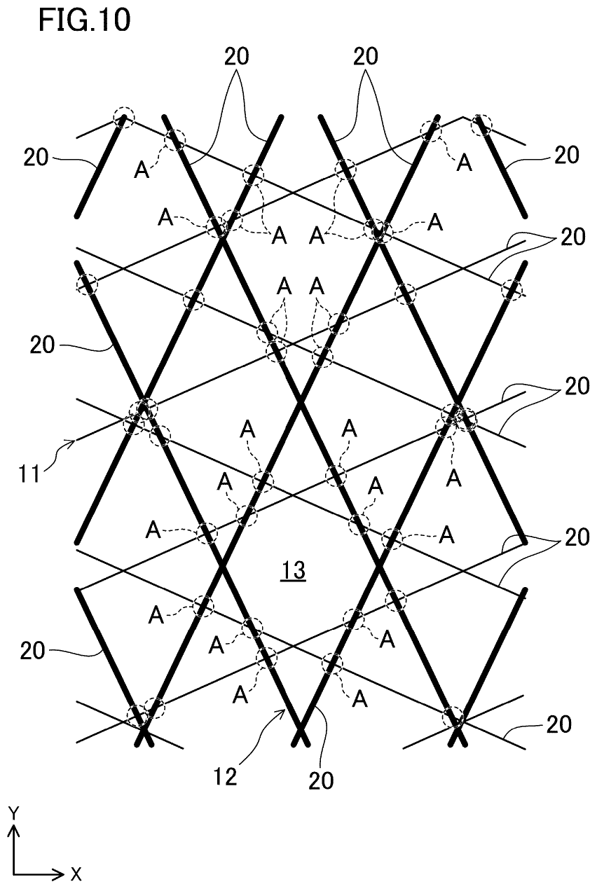

As a characteristic configuration of the embodiment of the present disclosure, at the node, at least two or more fine lines 20, 20 among the plurality of fine lines 20 constituting the transmission electrode 11 intersect, at at least two or more intersection points, with at least one fine line 20 corresponding to at least one side of the quadrangular shape of each cell 13 constituting the reception electrode 12. For example, in an arbitrary cell 13 (second cell) constituting the reception electrode 12 shown in FIGS. 10 and 11, the fine line 20 corresponding to each side of the quadrangular shape intersects two fine lines 20, 20 among the plurality of fine lines 20 forming the cells 13 (first cells) of the transmission electrode 11 (first electrode) at two intersection points (intersection points A, A). In FIGS. 10 and 11, the plurality of fine lines 20 constituting the reception electrode 12 are indicated with thick lines in order to illustrate the plurality of fine lines 20 constituting the transmission electrode 11 and the plurality of fine lines 20 constituting the reception electrode 12 distinguishably from each other.

Here, the above-mentioned two intersection points (intersection points A, A) in each cell 13 (second cell) of each reception electrode 12 (second electrode) correspond to a “first intersection point” and a “second intersection point” in the present disclosure. Furthermore, a side of each cell 13 (second cell) of each reception electrode 12 (second electrode) that contains the first intersection point and the second intersection point, which overlap the corresponding cell 13 (first cell) of the corresponding transmission electrode 11 (first electrode) in a top view, corresponds to the “first side” in the present disclosure.

As shown in FIG. 11, in each cell 13 (second cell) of each reception electrode 12 (second electrode), pairs of the first intersection point and the second intersection point are located on opposite sides across the third diagonal line d3. It is therefore possible to prevent the intersection points from being concentrated at a certain region, as compared to the case where the pairs of the first intersection point and the second intersection point are located on the same side relative to the third diagonal line d3. That is, in the view area V of the touch sensor 1, it is possible to prevent significant variations in the number of intersection points per unit area corresponding to 1 square millimeter (hereinafter referred to as “unit area”), depending on the location. In other words, it is possible to prevent a smaller number of intersection points per unit area from occurring in any part of the view area V of the touch sensor 1.

As described below, if the number of intersection points per unit area falls below a certain value, the touch detection accuracy of the touch sensor 1 decreases.

By locating the pairs of the first intersection point and the second intersection point on opposite sides across the third diagonal line d3, it is possible to prevent the formation of a region with fewer intersection points, thereby avoiding a decrease in touch detection accuracy in such a region during a touch operation performed by a user onto the touch sensor 1. Thus, the intersection points are arranged in a well-balanced manner across the entire touch sensor 1, and therefore, it is possible to prevent a decrease in touch detection accuracy.

In the embodiment of the present disclosure, it is preferable that, at one node, the number of intersection points between the plurality of fine lines 20 constituting the transmission electrode 11 and the plurality of fine lines 20 constituting the reception electrode 12 (i.e., the number of intersection points A) is 3 or more and 97 or less in the unit area corresponding to 1 square millimeter (hereinafter, referred to as “unit area”).

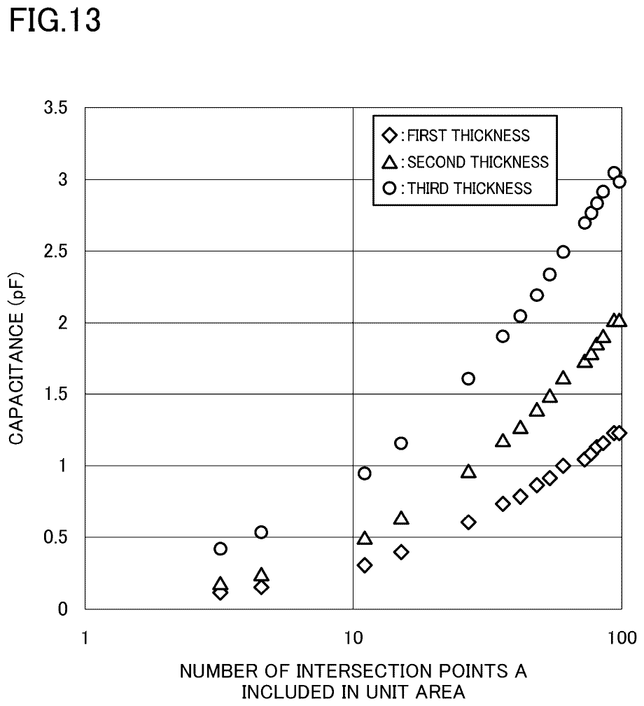

Table 1 and FIG. 13 show the results obtained through simulation, for each of the thicknesses of the touch sensor 1, regarding the relationship between the number of intersection points A included in the unit area and the capacitance (unit: pF) generated at the plurality of intersection points A included in the unit area. For example, in the case where the number of intersection points A included in the unit area is 3, the capacitance obtained through simulation is 0.113 pF for the first thickness. In the case where the number of intersection points A included in the unit area is 97, for example, the capacitance obtained through simulation is 2.99 pF for the third thickness. As long as the number of intersection points A included in the unit area is 3 or more and 97 or less, it is possible, with the capacitance corresponding to the number of intersection points A included in the unit area, to optimize the detection accuracy of the touch sensor 1 in detecting an action made when a user's finger or the like comes into contact with the operation screen 2b during a touch operation (such an action is hereinafter referred to as a “touch action”). That is, the above-described detection circuit connected to the touch sensor 1 can properly detect a touch action.

TABLE 1

| | |
|---|---|
| Number of | |
| Intersection Points | Capacitance [unit: pF] |

| per mm² | First | Second | Third |
|---|---|---|---|
| [unit: count] | Thickness | Thickness | Thickness |
| 3 | 0.113 | 0.180 | 0.421 |
| 4 | 0.152 | 0.246 | 0.535 |
| 11 | 0.306 | 0.499 | 0.949 |
| 15 | 0.396 | 0.637 | 1.160 |
| 27 | 0.605 | 0.966 | 1.611 |
| 36 | 0.737 | 1.181 | 1.908 |
| 41 | 0.786 | 1.275 | 2.051 |
| 48 | 0.866 | 1.394 | 2.195 |
| 53 | 0.917 | 1.491 | 2.342 |
| 60 | 1.001 | 1.617 | 2.499 |
| 72 | 1.045 | 1.735 | 2.701 |
| 76 | 1.083 | 1.793 | 2.772 |
| 80 | 1.133 | 1.859 | 2.838 |
| 84 | 1.162 | 1.913 | 2.921 |
| 93 | 1.234 | 2.023 | 3.053 |
| 97 | 1.232 | 2.025 | 2.990 |

Table 2 shows detailed numerical values regarding the thicknesses of the touch sensor 1 (i.e., numerical values for each of the “first thickness,” the “second thickness,” and the “third thickness”) used in the above-mentioned simulation for Table 1 and FIG. 13. In the simulation for Table 1 and FIG. 13, the capacitance values were obtained using “FineQap” provided by Jedat Inc.

TABLE 2

| | Composition/Material | | | | | |
|---|---|---|---|---|---|---|
| | First Thickness | | Second Thickness | | Third Thickness | |
| | Thickness | Relative | Thickness | Relative | Thickness | Relative |
| | (um) | Permittivity | (um) | Permittivity | (um) | Pennittivity |
| Cover Member/Glass | 1100 | 7.5 | 2500 | 7.5 | 300 | 7.5 |
| Adhesive Layer/OCA | 100 | 4.2 | 200 | 4.2 | 50 | 4.2 |
| Second Electrode/Copper | 1 | — | 1 | — | 1 | — |
| Second Layer/Acrylic | 2 | 3.9 | 2 | 3.9 | 2 | 3.9 |
| First Layer/PET | 50 | 3.2 | 100 | 3.2 | 30 | 3.2 |
| Second Layer/Acrylic | 2 | 3.9 | 2 | 3.9 | 2 | 3.9 |
| First Electrode/Copper Pattem | 1 | — | 1 | — | 1 | — |
| Adhesive Layer/OCA | 50 | 4.2 | 30 | 4.2 | 350 | 4.2 |
| Display/PET | 50 | 3.2 | 30 | 3.2 | 200 | 3.2 |
| Display/Conductive Material | 1 | — | 1 | — | 1 | — |

### (Dummy Patterns)

As shown in FIGS. 8 and 11, each reception electrode 12 (second electrode) includes dummy patterns 15. In a plan view, the dummy pattern 15 is located inside each cell 13 (second cell) constituting the reception electrode 12 (second electrode). In FIG. 10, the dummy patterns 15 are not shown for convenience of illustration.

Each dummy pattern 15 is constituted by a plurality of dummy fine lines 25. Specifically, the dummy pattern 15 is configured as a mesh pattern in which a plurality of cells defined by the plurality of dummy fine lines 25 are arranged. The dummy pattern 15 is configured such that the distance LD2 (see FIG. 8) between the dummy fine lines 25, 25 adjacent to each other is in the range of 100 μm or more and 500 μm or less. In this embodiment, each dummy fine line 25 continuously extends from one side of the quadrangular shape of each cell 13 constituting the reception electrode 12 toward the other side opposite to the one side. In FIG. 11, for convenience of illustration, the plurality of dummy fine lines 25 outside the arbitrary cell 13 are not shown.

The dummy pattern 15 is electrically insulated from the plurality of fine lines 20 forming the cell 13 of the reception electrode 12. Specifically, ends of the dummy fine lines 25 forming the dummy pattern 15 are spaced apart from the plurality of fine lines 20 forming the cell 13 of the reception electrodes 12. That is, the dummy fine lines 25 constituting the dummy pattern 15 do not intersect the plurality of fine lines 20 constituting the reception electrodes 12. Furthermore, the dummy fine lines 25 forming the dummy pattern 15 are electrically insulated from an electrode connection portion 17, which will be described later.

Each first cell constituting each transmission electrode 11 (first electrode) intersects the dummy patterns 15 in a top view. Specifically, as shown in FIG. 11, in the arbitrary cell 13 (in the quadrangular region in the second cell) constituting the reception electrode 12, each of the fine lines 20 constituting the transmission electrode 11 intersects the plurality of dummy fine lines 25. In FIG. 11, the intersection points between the fine lines 20 constituting the transmission electrode 11 and the dummy fine lines 25 are denoted by the reference sign B. In the arbitrary cell 13 shown in FIG. 11, one fine line 20 constituting the transmission electrode 11 intersects four or five dummy fine lines 25.

In the arbitrary cell 13 shown in FIG. 11, there are 19 intersection points B, and the number of intersection points B is greater than the number of intersection points A (i.e., eight). That is, the embodiment of the present disclosure is configured such that, in each cell 13 constituting the reception electrode 12 (i.e., in each quadrangular region in the second cell), the number of intersection points between the plurality of fine lines 20 constituting the transmission electrode 11 and the plurality of dummy fine lines 25 (i.e., the number of intersection points B) is greater than the number of intersection points between the plurality of fine lines 20 constituting the transmission electrode 11 and all the sides of the quadrangular shape of the cell 13 (i.e., the number of intersection points A).

### (Dummy Electrodes)

As shown in FIG. 8, a dummy electrode 16 is provided between two reception electrodes 12, 12. The dummy electrode 16 is constituted by a plurality of dummy fine lines 25. Specifically, the dummy electrode 16 is configured as a mesh pattern in which a plurality of cells defined by the plurality of dummy fine lines 25 are arranged. The dummy electrode 16 is configured such that the distance LD3 between the dummy fine lines 25, 25 adjacent to each other is in the range of 100 μm or more and 500 μm or less. Preferably, the distance LD3 is substantially equal to the distance LD1 and the distance LD2.

Each dummy electrode 16 is electrically insulated from the reception electrodes 12. Specifically, as shown in FIG. 8, ends of the dummy fine lines 25 constituting each dummy electrode 16 are spaced apart from the fine lines 20 forming the cells 13 of the reception electrodes 12. That is, the dummy fine lines 25 constituting the dummy electrodes 16 do not intersect the plurality of fine lines 20 constituting the reception electrodes 12. Furthermore, the dummy fine lines 25 constituting the dummy electrodes 16 are electrically insulated from the electrode connection portions 17, which will be described later.

### (Electrode Connection Portions)

As shown in FIG. 8, the transmission electrodes 11 and reception electrodes 12 each include electrode connection portions 17. Each electrode connection portion 17 is formed of a fine line similar to the fine lines 20. The electrode connection portions 17 are located near the ends of the transmission electrodes 11 and reception electrodes 12. The electrode connection portions 17 are electrically connected to the plurality of fine lines 20 constituting the cells 13. The electrode connection portions 17 are designed to have a line width greater than the line width of the plurality of fine lines 20 constituting the cells 13.

### (Sectional Structure of Fine Lines)

Each fine line 20 includes a conductive material buried in the corresponding groove 6. As shown in FIG. 12, each fine line 20 includes an adhesion layer 21, a seed layer 22, a conductive layer 23, and a blackened layer 24. Similarly to each fine line 20, each dummy fine line 25 also includes such an adhesion layer 21, seed layer 22, conductive layer 23, and blackened layer 24, and thus the sectional structure of each dummy fine line 25 is not illustrated.

The adhesion layer 21 is an element for ensuring the adhesiveness of the seed layer 22 to the groove 6. The adhesion layer 21 has a function of making the fine line 20 less visible when viewed by a user from the operation screen 2b side.

The adhesion layer 21 is, for example, a metal layer made of a metal nitride or a metal oxide containing at least one metal selected from the group consisting of Ti, Al, V, W, Ta, Si, Cr, Ag, Mo, Cu, and Zn. The adhesion layer 21 may be a single layer or a stack of a plurality of layers with different compositions. The adhesion layer 21 is stacked as a thin film on the groove 6 by vapor deposition or sputtering, for example.

The seed layer 22 functions to bond the conductive layer 23 to the adhesion layer 21. Specifically, when electroplating for forming the conductive layer 23 is conducted, for example, the seed layer 22 functions as a cathode for depositing a plating solution, which will be described later, containing copper (Cu) or the like in this embodiment on the adhesion layer 21. The seed layer 22 is stacked as a thin film on the adhesion layer 21 by vapor deposition or sputtering, for example.

The conductive layer 23 is formed by an electroplating process, for example. In the case where the electroplating process is employed, the seed layer 22 and the conductive layer 23 are integrally formed. This makes the interface between the seed layer 22 and the conductive layer 23 unidentifiable.

The blackened layer 24 is stacked on a surface of the conductive layer 23. The blackened layer 24 is formed through substitution of palladium for copper at the boundaries between copper crystal grains on the surface of the conductive layer 23 (i.e., through blackening treatment). The thickness of the blackened layer 24 is, for example, 7 nm or more and 10 nm or less. The blackened layer 24 has a function of making the fine lines 20 less visible when viewed by a user from the operation screen 2b side.

### (Wiring Portions)

The touch sensor 1 includes a plurality of wiring portions. The plurality of wiring portions are elements for electrically connecting the plurality of transmission electrodes 11 and the plurality of reception electrodes 12 to external circuits (not shown) (such as the driving circuit and the detection circuit described above). The wiring portions are formed of fine lines similar to the fine lines 20.

As shown in FIGS. 3 to 5, the plurality of wiring portions include a plurality of first wiring portions 31 and a plurality of second wiring portions 32. The plurality of first wiring portions 31 and the plurality of second wiring portions 32 are located outside the view area V (see FIG. 1). Specifically, the plurality of first wiring portions 31 and the plurality of second wiring portions 32 overlap the decorative portion 2a (see FIGS. 1 and 2) in a plan view viewed from the operation screen 2b side. That is, the plurality of first wiring portions 31 and the plurality of second wiring portions 32 are invisible from the operation screen 2b side due to the decorative portion 2a.

As shown in FIG. 4, the plurality of first wiring portions 31 are on the back surface of the substrate 3. One end of each first wiring portion 31 is electrically connected to an end of the corresponding transmission electrode 11 (i.e., to the corresponding electrode connection portion 17). The plurality of first wiring portions 31 are arranged such that the other ends of the first wiring portions 31 converge near the substantial center of the lower side of the substrate 3.

The plurality of second wiring portions 32 are on the front surface of the substrate 3. One end of each second wiring portion 32 is electrically connected to an end of the corresponding reception electrode 12 (i.e., to the corresponding electrode connection portion 17). The plurality of second wiring portions 32 are arranged such that the other ends of the second wiring portions 32 converge near the substantial center of the lower side of the substrate 3.

### (Pads)

As shown in FIGS. 3 to 5, at the other end of each wiring portion, a pad 33 is provided to electrically connect the wiring portion to the flexible wiring board 8. The pads 33 are formed of fine lines similar to the fine lines 20.

### (First and Second Ground Portions)

As shown in FIGS. 4 and 5, the touch sensor 1 includes first and second ground portions 34 and 35 set to the ground potential. The first and second ground portions 34 and 35 are electrically insulated from the plurality of sensor electrodes and the plurality of wiring portions. The first and second ground portions 34 and 35 are located outside the view area V (see FIG. 1). Specifically, the first and second ground portions 34 and 35 are disposed to surround the outer periphery of the view area V.

As shown in FIG. 4, the first ground portion 34 is on the back surface of the substrate 3. The first ground portion 34 is located near the peripheral edge of the back surface of the substrate 3. The pads 33, 33 described above are provided at an intermediate portion of the first ground portion 34 (an intermediate portion near the substantial center of the lower side of the substrate 3).

As shown in FIG. 5, the second ground portion 35 is on the front surface of the substrate 3. The second ground portion 35 is located near the peripheral edge of the front surface of the substrate 3. Both ends of the second ground portion 35 are located near the substantial center of the lower side of the substrate 3. The above-described pads 33, 33 are provided at the both ends of the second ground portion 35.

### Problems in Known Techniques

In the technical field of touch sensors, indium tin oxide (ITO) has been widely used as an example of a material forming an electrode. Known electrodes made of ITO have characteristics that the electrodes tend to have relatively large resistance and that the current response speed between the electrodes tends to decrease as the size of the touch sensor increases. Because of such characteristics, a touch sensor employing electrodes made of ITO may not have achieved sufficient accuracy in detecting touch actions (“touch detection accuracy”). Due to this, the touch sensor disclosed in Patent Document 1 mentioned above (International Publication No. WO2015/060059) aimed to improve touch detection accuracy by using electrode patterns each formed by a plurality of thin metal wires and by specifically defining the area of each intersection portion between the electrode patterns.

However, at the intersection portion in the touch sensor of Patent Document 1, the plurality of thin metal wires are not present over the entire area of the intersection portion (i.e., the region specified at the intersection portion). That is, most of the area of the intersection portion is occupied by a portion where the plurality of thin metal wires are not present (see FIG. 6 of Patent Document 1). For this reason, in the configuration using such electrode patterns formed by a plurality of thin metal wires, it has not been possible to properly calculate the capacitance of the electrodes merely by substituting a specific numerical value for the area of the above-mentioned intersection portion into the variable corresponding to “the area of the electrodes” in the general formula for calculating the electrostatic capacitance (specifically, the general formula expressing that the capacitance is proportional to the “permittivity of the electrodes” and “the area of the electrodes,” while it is inversely proportional to “the distance between the electrodes”). That is, simply specifying the area of the intersection portion has been insufficient as a factor for optimizing touch detection accuracy.

On the other hand, referring to FIG. 6 of Patent Document 1, in each cell located within the intersection portion, a single thin metal wire constituting one electrode pattern (the first electrode pattern in Patent Document 1) intersects, at only one intersection point, with each side of the cell constituting the other electrode pattern (second electrode pattern in Patent Document 1). The inventors of the present disclosure focused on this configuration of the known technique, and inferred that, in the intersection portion between the electrode patterns, the number of intersection points between the single fine line constituting the one electrode pattern and each side of each cell constituting the other electrode pattern may contribute to the stabilization of the electrostatic capacitance generated at the intersection portion (i.e., the optimization of touch detection accuracy).

### Advantageous Effects of Embodiments

Based on the above inference, the inventors of the present disclosure have found the characteristic configuration as described above. That is, as a characteristic configuration according to the embodiment of the present disclosure, at each node, at least two or more fine lines 20, 20 among the plurality of fine lines 20 constituting the transmission electrode 11 (first electrode) intersect, at at least two or more intersection points (the first intersection point and the second intersection point corresponding to the intersection points A, A shown in FIG. 10 and FIG. 11), with at least one fine line 20 corresponding to at least one side of the quadrangular shape of each cell 13 (each second cell) constituting the reception electrode 12 (second electrode). In this configuration, the total number of intersection points A in each cell 13 constituting the reception electrode 12 within the node increases as compared to the configuration of the known technique described above. This consequently helps, at the node, to obtain the electrostatic capacitance stably, which is generated in each cell 13 (each second cell) constituting the reception electrode 12 (second electrode). Thus, with the touch sensor according to the embodiment of the present disclosure, touch detection accuracy can be optimized.

Each reception electrode 12 (second electrode) may include the dummy patterns 15 electrically insulated from the plurality of fine lines 20 constituting the reception electrode 12 (second electrode). The dummy patterns 15 can reduce a rise in the capacitance in each reception electrode 12. Since the dummy patterns 15 are provided, the plurality of fine lines 20 constituting each reception electrode 12 are less distinguishable from the plurality of dummy fine lines 25 constituting the dummy patterns 15 when viewed by a user of the touch sensor 1 from the operation screen 2b side. That is, the plurality of fine lines 20 constituting each reception electrode 12 are less noticeable from the operation screen 2b side. As a result, the appearance of the touch sensor 1 can be improved.

Each fine line 20 constituting the transmission electrode 11 (first electrode) intersects the plurality of dummy fine lines 25 located within each cell 13 (within the quadrangular region in each second cell) constituting the reception electrode 12 (second electrode). At the intersection points between the fine lines 20 constituting the transmission electrode 11 and the dummy fine lines 25 (i.e., at the intersection points B shown in FIG. 11), electrostatic capacitance is generated, which is smaller than the electrostatic capacitance generated at the intersection points between the fine lines 20 constituting the transmission electrode 11 and the fine lines 20 constituting the reception electrode 12 (i.e., at the intersection points A shown in FIG. 11). Using such a slight electrostatic capacitance generated at the intersection points B, it is possible to finely adjust the required electrostatic capacitance value generated at the node. With this, touch detection accuracy can be further optimized.

In addition, in each cell 13 constituting the reception electrode 12 (second electrode) (i.e., in each quadrangular region in each second cell), the number of intersection points between the corresponding fine lines 20 constituting the plurality of transmission electrodes 11 (the plurality of first electrodes) and the plurality of dummy fine lines 25 (i.e., the number of intersection points B shown in FIG. 11 as an example) is greater than the number of intersection points between the corresponding fine lines 20 constituting the plurality of transmission electrodes 11 (the plurality of first electrodes) and all the sides of the quadrangular shape of the cell 13 (i.e., the number of intersection points A shown in FIG. 11 as an example). Thus, in each cell 13 (second cell) constituting the reception electrode 12 (second electrode), the number of intersection points B, where a slight electrostatic capacitance can be generated, is greater than the number of intersection points A. This makes it easier to finely adjust the required electrostatic capacitance value generated at the node. With this, touch detection accuracy can be further optimized.

Furthermore, at the node, the number of intersection points between the plurality of fine lines 20 constituting the transmission electrode 11 (first electrode) and the plurality of fine lines 20 constituting the reception electrode 12 (second electrode) (i.e., the number of intersection points A) is 3 or more and 97 or less in the unit area corresponding to 1 square millimeter. In this configuration, the capacitance generated at the node can be kept within the numerical range (see the simulation results shown in FIG. 13) required for optimizing touch detection accuracy.

### OTHER EMBODIMENTS

In the above embodiment, the substantially rectangular view area V is used. However, the present disclosure is not limited to this configuration. The view area V may have, for example, a substantially circular shape or a polygonal shape such as a pentagonal shape in a plan view.

While the single substrate 3 is used in the above embodiment, the present disclosure is not limited to this configuration. That is, two substrates (not shown) may be used. Although not shown, two substrates may be used, in which the second layer 5 is stacked on the front surface or the back surface of the first layer 4.

While the substrate 3 includes the first layer 4 and the second layers 5 in the above embodiment, the present disclosure is not limited to this configuration. For example, the substrate 3 may include only the first layer 4. In such a configuration, it is merely required that the plurality of grooves 6 be provided on at least one of the front surface or the back surface of the first layer 4.

In the above embodiment, the direction from the left to the right on the sheet of FIG. 3 is defined as the first direction X, while the direction from the bottom to the top on the sheet of FIG. 3 is defined as the second direction Y. However, the present disclosure is not limited to this. That is, the direction from the bottom to the top on the sheet of FIG. 3 may be defined as the first direction X, while the direction from the left to the right on the sheet of FIG. 3 may be defined as the second direction Y. In this case, although not shown, the second diagonal line d2 of the first cell and the third diagonal line d3 of the second cell extend in the direction from the bottom to the top on the sheet of FIG. 3. On the other hand, the first diagonal line d1 of the first cell and the fourth diagonal line d4 of the second cell extend in the direction from the left to the right on the sheet of FIG. 3.

In the above embodiment, the plurality of transmission electrodes 11, the plurality of first wiring portions 31, and the first ground portion 34 are provided on the back surface of the substrate 3, while the plurality of reception electrodes 12, the plurality of second wiring portions 32, and the second ground portion 35 are provided on the front surface of the substrate 3. However, the present disclosure is not limited to this configuration. For example, although not shown, the plurality of transmission electrodes 11, the plurality of first wiring portions 31, and the first ground portion 34 may be provided on the front surface of the substrate 3, while the plurality of reception electrodes 12, the plurality of second wiring portions 32, and the second ground portion 35 may be provided on the back surface of the substrate 3. Even in this configuration, the dummy patterns 15 and the dummy electrodes 16 are disposed on the front surface of the substrate 3 (i.e., the surface of the substrate 3 that is on the viewing side of the touch sensor 1).

While the above embodiment illustrates the touch sensor 1 with the cover member 2 and the flexible wiring board 8 attached to the substrate 3, the present disclosure is not limited to this configuration. Specifically, the concept of the touch sensor 1 of the present disclosure includes the state in which the cover member 2, the flexible wiring board 8, and the like have not been attached to the substrate 3 yet. Furthermore, the concept of the touch sensor 1 of the present disclosure includes the configuration in which the transmission electrodes 11, the reception electrodes 12, the first wiring portions 31, the second wiring portions 32, and the plurality of pads 33 are formed on an original elongated base material (e.g., an elongated hoop-shaped member (not shown)) from which individual substrates 3 are formed.

While the above embodiment illustrates the configuration in which each first cell and each second cell have the shape of a rhombus, the present disclosure is not limited to this configuration. That is, each first cell is only required to have a quadrangular shape defined by the imaginary first diagonal line d1 and the imaginary second diagonal line d2 that is longer than the first diagonal line d1. Similarly, each second cell is only required to have a quadrangular shape defined by the imaginary third diagonal line d3 and the imaginary fourth diagonal line d4 that is longer than the third diagonal line d3.

While the above embodiment illustrates the configuration in which the transmission electrodes 11 include no dummy pattern 15, the present disclosure is not limited to this configuration. That is, the transmission electrodes 11 may include dummy patterns (not shown) similar to the dummy patterns 15 described in the above embodiment. In this case, similarly to the dummy patterns 15 of the reception electrodes 12, the dummy patterns of the transmission electrodes 11 are constituted by a plurality of dummy fine lines (not shown). Furthermore, in a plan view, the dummy patterns of the transmission electrodes 11 are located inside the cells 13 constituting the transmission electrodes 11.

While the above embodiment illustrates the configuration in which no dummy electrode 16 is provided between two transmission electrodes 11, 11, the present disclosure is not limited to this configuration. For example, if the electrode width EW1 of the transmission electrodes 11 is relatively small, a dummy electrode (not shown) may be provided between two transmission electrodes 11, 11. Such a dummy electrode is constituted by a plurality of dummy fine lines (not shown), similarly to the dummy electrodes 16 shown in FIG. 8.

In the above embodiment, the plating solution containing copper (Cu) as a main component is described; however, the present disclosure is not limited to this. For example, the plating solution may contain silver, gold, or a copper alloy.

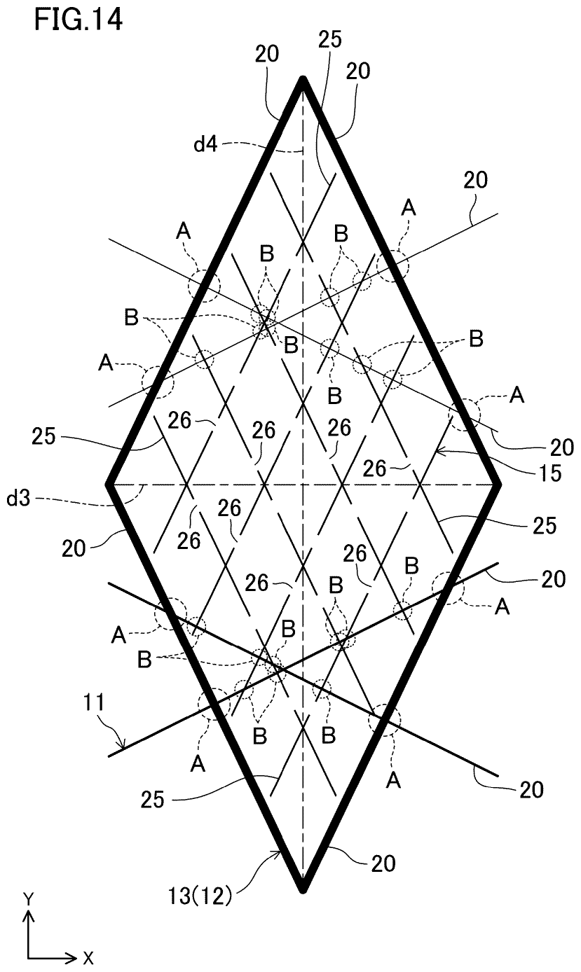

While the above embodiment illustrates the configuration in which the dummy fine lines 25 of the dummy patterns 15 extend continuously, the present disclosure is not limited to this configuration. For example, as shown in FIG. 14, each dummy fine line 25 may extend discontinuously from one side of the quadrangular shape of each cell 13 constituting the reception electrode 12 toward the other side opposite to the one side. Specifically, each dummy fine line 25 may be provided with at least one slit 26.

### INDUSTRIAL APPLICABILITY

The present disclosure is industrially applicable as a touch sensor.

### DESCRIPTION OF REFERENCE CHARACTERS

1 Touch Sensor
2 Cover Member
3 Substrate
11 Transmission Electrode (First Electrode)
12 Reception Electrode (Second Electrode)
13 Cell (First Cell or Second Cell)
14 Mesh Pattern
15 Dummy Pattern
16 Dummy Electrode
17 Electrode Connection Portion
20 Fine Line
25 Dummy Fine Line
26 Slit
31 First Wiring Portion
32 Second Wiring Portion
33 Pad
34 First Ground Portion
35 Second Ground Portion
d1 First Diagonal Line
d2 Second Diagonal Line
d3 Third Diagonal Line
d4 Fourth Diagonal Line

1. A touch sensor comprising:
a first electrode that extends in a first direction; and
a second electrode that extends in a second direction orthogonal to the first direction and overlaps the first electrode in a top view,
the first electrode including a first cell having a quadrangular shape,
the second electrode including a second cell having a quadrangular shape,
a length of the first cell along the first direction being greater than a length of the first cell along the second direction,
a length of the second cell along the second direction being greater than a length of the second cell along the first direction,
the second cell including a first side containing a first intersection point and a second intersection point, the first and second intersection points overlapping the first cell in a top view.

2. The touch sensor of claim 1, wherein
the length of the first cell along the first direction is equal to a length of a second diagonal line of the first cell, the second diagonal line extending along the first direction,
the length of the first cell along the second direction is equal to a length of a first diagonal line of the first cell, the first diagonal line extending along the second direction,
the length of the second cell along the second direction is equal to a length of a fourth diagonal line of the second cell, the fourth diagonal line extending along the second direction,
the length of the second cell along the first direction is equal to a length of a third diagonal line of the second cell, the third diagonal line extending along the first direction, and
pairs of the first intersection point and the second intersection point are located on opposite sides across the third diagonal line.

3. The touch sensor of claim 1, wherein
the second electrode further includes a dummy pattern that is electrically insulated from the second cell and is located inside the second cell.

4. The touch sensor of claim 3, wherein
the first cell intersects the dummy pattern in a top view.

5. The touch sensor of claim 4, further comprising
a cover member located above the second electrode and including an operation screen, wherein
the second electrode is located above the first electrode.

6. The touch sensor of claim 3, wherein
the first electrode includes a plurality of first electrode cells,
each of the plurality of first electrode cells is the first cell,
the second electrode includes a plurality of second electrode cells,
each of the plurality of second electrode cells is the second cell, and
the number of intersection points between the dummy pattern and each of the plurality of first electrode cells in a top view is greater than the number of intersection points between the second cell and each of the plurality of first electrode cells in a top view.

7. The touch sensor of claim 1, wherein
the first electrode includes a plurality of first electrode cells,
each of the plurality of first electrode cells is the first cell,
the second electrode includes a plurality of second electrode cells,
each of the plurality of second electrode cells is the second cell, and
the number of intersection points between the plurality of first electrode cells and the plurality of second electrode cells is 3 or more and 97 or less in a unit area corresponding to 1 square millimeter.
